(19) United States
(12) Patent Application Publication
(10) Pub. No.: US 2007/0107039 A1
(43) Pub. Date: May 10, 2007

(54) Content presentation device communicating with another device through presented content

(75) Inventors: Harumitsu Miyakawa, Shiki-gun (JP); Katsuo Doi, Sakurai-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/594,830

(22) Filed: Nov. 9, 2006

(30) Foreign Application Priority Data
Nov. 10, 2005 (JP) 2005-325951(P)
Sep. 27, 2006 (JP) 2006-262868 (P)

(51) Int. Cl. H04N 7/16

(52) U.S. Cl. 725/142; 725/143; 725/135

(57) ABSTRACT

First and second devices establish communication including conversation therebetween through a network. The first device transmits to the second device a content data list of a TV broadcast program (content data) and the like stored in its storing unit. At that time, the first device receives from the second device a content data list of a TV broadcast program and the like, the content data list being read from a storing unit of the second device. Similarly, the second device receives the content data list from the first device. Each of the first and second devices compares the content data list in its own storing unit and the received content data list, and based on a comparison result, searches its own storing unit. Through the search, identical content data owned by both of the first and second devices is displayed at the first and second devices.

This nonprovisional application is based on Japanese Patent Applications Nos. 2005-325951 and 2006-262868 filed with the Japan Patent Office on Nov. 10, 2005 and Sep. 27, 2006, respectively, the entire contents of which are hereby incorporated by reference.

### BACKGROUND OF THE INVENTION

1. Field of the Invention

The present invention relates to a content presentation device, and particularly to a content presentation device communicating with another device through a presented content.

2. Description of the Background Art

As means for holding a conversation through a network having a plurality of apparatuses connected thereto, there is utilized voice transmission means, a typical example of which is a telephone. Additionally, as means for transmitting a video picture, an image, a character and others, there are utilized a television (TV) telephone and a video messenger such as a Windows (R) Messenger available from Microsoft Corporation. The Windows (R) Messenger provides means for transmitting a display of a personal computer application to a terminal on the other side to utilize the display for assisting conversation and offering an explanation. In the Windows (R) Messenger, a still image and a character are utilized to assist conversation.

In contrast, there have become popular in recent years an apparatus such as Hard Disk (HDD) recorder, with which many content data items of television broadcast programs are recorded to be viewed and listened at the time other than the broadcast time, and an apparatus with which a music Compact Disks (CDs) are stored in a home server within the scope of personal use so that one can enjoy listening music without exchanging the CDs. These apparatuses can be connected to an Ethernet (R) and a wireless Local Area Network (LAN), which makes it possible to obtain a list of contents from another apparatus through a home network at home, and replay a content. Furthermore, as a capacity of a storage device is increased, these apparatuses can store many broadcast contents and CD contents.

Under the circumstances, there have been proposed many functions of presenting information on a content. Japanese Patent Laying-Open No. 2004-118737 introduces a content in the context of communication. Japanese Patent Laying-Open No. 2004-173252 introduces a popular content supported by many people. Japanese Patent Laying-Open No. 2003-076704 presents viewers and listeners who tend to have similar interest. Japanese Patent Laying-Open No. 2003-087826 introduces viewers and listeners who tend to have similar interest. Japanese Patent Laying-Open No. 2003-223406 provides various functions of presenting information from a viewpoint of communication enhancement, such as a function of acquiring information on an interesting topic from user information (profile) and providing a subject matter that could be topical to both of the users, in the form of a world wide web (WEB) page.

As to these functions of presenting information in video communication, communication apparatuses cannot acquire content lists from recording apparatuses or music data storage devices in their own home networks, respectively, prior to the start of communication or during communication, exchange information with a particular apparatus on the other side, allow communicating persons to mutually recognize identical recorded content and tune existing on both sides of the persons, select the identical content, and replay the same simultaneously. When voice data and video data are transmitted from one side to the other side to replay the same content simultaneously, an amount of data to be transmitted must fall within a transmissible capacity of the network, and the copyrighted content must not be transmitted (delivered) to the third party without permission, from a viewpoint of copyright protection.

The situation in which both persons watch the same content and enjoy conversation by telephone, for example, is effective for them to enjoy a close family atmosphere at a living room, even if they are at remote locations. However, owing to limitations as described above, it is often difficult to enjoy such an atmosphere. Under the circumstances, it has been demanded by a user to provide a function capable of implementing an environment in which persons communicating with each other can browse or view and listen the same content and establish communication (conversation) with each other.

### SUMMARY OF THE INVENTION

An object of the present invention is to provide a content presentation device capable of presenting the same (identical) content and allowing communication with a device on the other side.

In order to achieve the object above, according to a certain aspect of the present invention, a content presentation device includes a content storing unit storing contents and relevant information pieces relating to the contents, in a manner allowing the relevant information pieces to correspond to the contents, respectively, and an output unit. The content presentation device communicates with an external device. Here, the content presentation device communicating with the external device is referred to as a “first (one) content presentation device”, while the external device is referred to as a “second (the other) content presentation device”, which has a functional configuration similar to that of the first content presentation device. The first content presentation device includes: an information receiving unit receiving relevant information pieces read from a content storing unit in the second content presentation device and transmitted; a comparison unit comparing the relevant information pieces received by the information receiving unit and the relevant information pieces read from its own content storing unit, and outputting a comparison result; and a presentation unit. The presentation unit retrieves, from the content storing unit of the first content presentation device, based on the comparison result output from the comparison unit, a content identical to a content stored in a content storing unit in the second content presentation device and presents the content through the output unit.

Although the content storing unit is embedded in the content presentation device, it may be separate from the content presentation device. The content presentation device and the separate content storing unit are coupled by a signal transmitting unit such as the Ethernet (R) or the wireless local area network (LAN), in order that the content presentation device may access the content storing unit. An example of the content presentation device accessing the content storing unit through the signal transmitting unit includes, for example, a device accessible to the content storing unit through a home network according to a Digital Living Network Alliance (R) (DLNA (R)) or through a file sharing system, or a Video On Demand (VoD) device accessible to the subscribed content.

Accordingly, the content presentation device transmits the relevant information pieces stored in its own content storing unit to the other content presentation device and receives the relevant information pieces stored in the other content presentation device from the other content presentation device, compares the relevant information pieces received from the other device and the relevant information pieces owned by itself, and based on the comparison result, retrieves and presents a content identical to a content stored in the content storing unit of the other device. Accordingly, the content presentation devices can simultaneously present the identical content owned by them, even if the content presentation devices are separate from each other.

In this case, a content itself neither received nor transmitted between the content presentation devices, so that communication is possible without any regard of limitation on a transmission path (capacity or the like).

Furthermore, even if a content is copyrighted, the content is neither received nor transmitted between the content presentation devices, and hence copyright can be protected.

Preferably, the content presentation device is connected to a communication line. The content presentation device further includes a speech communication unit for holding conversation with a user of the second content presentation device through the communication line. Accordingly, the users of the content presentation devices can utilize their speech communication units to hold conversation with each other while they browse or view and listen the same content presented at their own output units, which allows them to enjoy a close family atmosphere at a living room, even if they are at remote locations.

Preferably, the comparison unit has a comparison and matching unit. The comparison and matching unit compares the relevant information pieces received by the information receiving unit and the relevant information pieces read from the content storing unit of the first content presentation device, and outputs a matching piece of the relevant information pieces, as a comparison result. Accordingly, the identical content can be specified if the relevant information pieces corresponding thereto match.

Preferably, the relevant information pieces include a comment on the content corresponding thereto. Accordingly, based on a result of comparison between the comments in the relevant information pieces, the identical content can be retrieved.

Preferably, the content presentation device further includes a unit communicating with an external information processing device storing information on the content, and based on the information on the content, which information is received from the information processing device, generating the relevant information pieces. The comparison unit has an update unit. The update unit updates the comment in the relevant information pieces received from the second content presentation device, by using the information on the content, which information is received from the information processing device, for comparison.

Accordingly, the update unit updates the comment in the relevant information pieces received from the second content presentation device, by using the information on the corresponding content, which information is received from the information processing device communicated by the first content presentation device. At that time, since the content presentation devices communicate with different information processing devices, there may be a case where comments in the relevant information pieces generated in the content presentation devices are different from each other, even if the comments are intended for the same content. Even in that case, the update unit can allow the comment to match with the comment in the relevant information pieces corresponding to the content in the content storing unit of the first content presentation device.

Accordingly, prior to the comparison between the relevant information pieces on the same content, the comments can be updated such that they match with each other. It is therefore possible to reliably retrieve the identical content, based on a result of comparison between the updated relevant information pieces.

Preferably, the relevant information pieces include a title or an elapsed time list of each of the contents corresponding thereto. When the contents corresponding thereto are a video picture, the elapsed time list shows a timing at which scenes are switched. When the contents corresponding thereto are a tune, the elapsed time list shows a time interval for which the tune continues or pauses.

Accordingly, it is possible to compare the titles of the contents in the relevant information pieces corresponding thereto, and based on a comparison result, retrieve the identical content. When the contents are a video picture, it is possible to retrieve the identical content, based on the result of comparison between the timings at which scenes of the video picture are switched. The detection of a scene change is a technique utilizing the fact that a motion vector is interrupted between adjacent frames of an image, and is a well-known technique used for generating a subhead in a program in a DVD recorder or the like. When the contents are a tune, it is possible to retrieve the identical content, based on the result of comparison between the time intervals for which the tune continues or pauses.

Preferably, the content presentation device further includes a presentation command generating unit generating a presentation command for instructing an operation for presenting the identical contents stored in both of the content presentation devices through the output unit, based on an external instruction, a presentation command transmitting unit transmitting the presentation command generated by the presentation command generating unit to the second content presentation device, and a presentation command receiving unit receiving a presentation command transmitted from the second content presentation device.

Furthermore, the presentation unit has a first presentation unit retrieving the identical content from the content storing unit and presenting the retrieved identical content through the output unit according to the instructed operation, based on the presentation command received by the presentation command receiving unit, and a second presentation unit retrieving the identical contents stored in both of the content presentation devices from the content storing unit and presenting the identical contents through the output unit according to the instructed operation, based on the presentation command generated by the presentation command generating unit.

Accordingly, when the presentation unit retrieves the identical content from the content storing units and presents the same, the presentation command is executed in the second presentation unit in the content presentation device generating the presentation command, and additionally, the presentation command is transmitted to the second content presentation device and executed in the first presentation unit in the second content presentation device. It is therefore possible to present the identical contents by means of the presentation units in both of the content presentation devices, by using the same presentation command and allowing the operations to be performed concurrently.

Accordingly, the identical contents stored in both of the content presentation devices are retrieved and presented while the operations instructed by the same presentation command are performed on the retrieved contents. It is therefore possible to replay the same scene of the content even if the content presentation devices are physically remote.

Preferably, the content presentation device further includes a response measurement unit measuring a response time required for transmitting the presentation command to the second content presentation device. When the presentation command transmitting unit transmits the presentation command to the second content presentation device, the second presentation unit modifies the operation, which is intended for the content and instructed by the presentation command, based on the response time measured by the response measurement unit.

Accordingly, when the presentation command is transmitted to the second content presentation device and then executed in the first presentation unit, the second presentation unit of the first content presentation device can, in anticipation of the response time required for the communication of the presentation command, modify the operation, which is intended for the content and instructed by the presentation command. Accordingly, the timings at which the content is operated (e.g. replay is started) can be brought in synchronization with each other between the content presentation devices.

Preferably, the content presentation device further includes a record command generating unit generating a record command for instructing an operation for recording a desired content in the content storing unit, based on an external instruction, a record command transmitting unit transmitting the record command generated by the record command generating unit to the second content presentation device, a record command receiving unit receiving a record command transmitted from a record command transmitting unit in the second content presentation device, and a unit performing an operation for storing the desired content in the content storing unit, based on the record command received by the record command receiving unit, and a unit performing an operation for storing the desired content in the content storing unit, based on the record command generated by the record command generating unit.

Accordingly, it is possible to concurrently store the identical contents in the content storing units in both of the content presentation devices, by using the same record command. It is therefore possible to store the identical contents in the content storage units in the contents presentation devices.

Preferably, the relevant information pieces received from the second content presentation device are discarded when a prescribed condition is established. It is therefore possible to clear a storage region for storing the received relevant information pieces whenever a prescribed condition is established, so that the storage region can effectively be utilized.

In order to achieve the above-described object, a content presentation method according to another aspect of the present invention, is a method using an information processing device including a storage unit storing contents and relevant information pieces relating to the contents, in a manner allowing the relevant information pieces to correspond to the contents, respectively, an output unit, and a communication unit. The method includes the steps of: receiving relevant information pieces read from a storage unit of the other information processing device and transmitted by a communication unit thereof; comparing the relevant information pieces received by the step of receiving and the relevant information pieces read from the storing unit of the one information processing device, and outputting a comparison result; and retrieving from the storage unit of the one information processing device, based on the comparison result output by the step of comparing, a content identical to a content stored in the other information processing device, and presenting the content through the output units.

In order to achieve the object above, a content presentation program according to still another aspect of the present invention is a program for executing the above-described method of presenting a content, by using a computer including a storage unit storing contents and relevant information pieces relating to the contents, in a manner allowing the relevant information pieces to correspond to the contents, respectively, an output unit, and a communication unit.

In order to achieve the object above, a machine-readable recording medium recording a content presentation program according to a further aspect of the present invention is a recording medium recording the above-described content presentation program for executing the content presentation method, by using a computer including a storing unit storing contents and relevant information pieces relating to the contents, in a manner allowing the relevant information pieces to correspond to the contents, respectively, an output unit, and a communication unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a configuration diagram of a system according to an embodiment.

FIGS. 2 and 3 are configuration diagrams of a computer according to the present embodiment.

FIGS. 4 and 5 are functional configuration diagrams of conversation devices according to the embodiment.

FIG. 6 is a flowchart of the entire process according to the embodiment.

FIGS. 7 and 8 are diagrams each showing a content list generated at each of the conversation devices in the embodiment.

FIG. 9 is a diagram showing a procedure for receiving and transmitting the content list according to the embodiment.

FIG. 10 is a flowchart showing that the content list is received and transmitted according to the embodiment.

FIGS. 11 and 12 are diagrams showing a comparison content list and an identical content list, respectively, according to the embodiment.

FIG. 13 is a process flowchart showing that the identical content list is generated according to the embodiment.

FIG. 14 is a process flowchart showing that scene change patterns are compared according to the embodiment.

FIG. 15 is a diagram showing that a content is selected from the identical content list according to the embodiment.

FIG. 16 is a diagram illustrating an identical viewing and listening command according to the embodiment.

FIG. 17 is a diagram showing a procedure for receiving and transmitting the identical viewing and listening command according to the embodiment.

FIG. 18 is a diagram showing a relationship among a program, a recording medium, and a device according to the embodiment.

FIG. 19 is a diagram showing how a desired content is selected from the displayed content list according to the embodiment.

### DESCRIPTION OF THE PREFERRED EMBODIMENTS

The embodiment of the present invention will hereinafter be described in detail with reference to the drawings.

In the present embodiment, a user utilizes a conversation device mounted on each of plurality of computers connected through a communication line. The conversation device also functions as a content presentation device, so that the same content can be presented simultaneously even in the different conversation devices. Accordingly, the users can view and listen the same presented content and establish communication (conversation) with other users through the conversation devices.

In the present embodiment, a content storing unit is embedded in a content presentation device. However, it may be separate from the content presentation device. The content presentation device and the separate content storing unit are coupled by signal transmission means such as the Ethernet (R) or the wireless LAN, in order that the content presentation device may access the content storing unit. An example of the content presentation device accessing the content storing unit through the signal transmission means, includes a device accessible to the content storing unit through a home network according to a DLNA (R) or through a file sharing system, or a VoD device accessible to a subscribed content.

The content refers to information on video picture data (including still image data and moving image data), voice data, tune data, and the like. Presentation of the content refers to display of a video picture through a display, and output of a voice through a loudspeaker and the like.

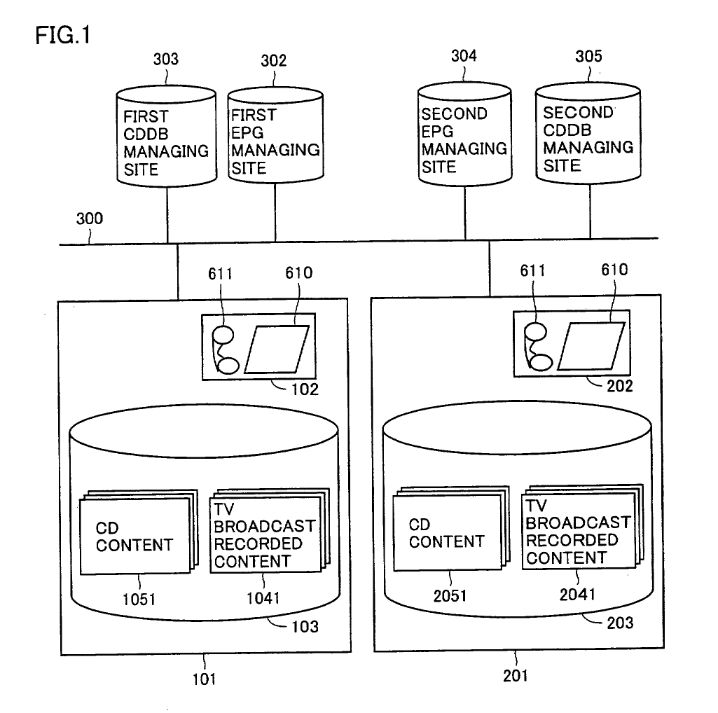

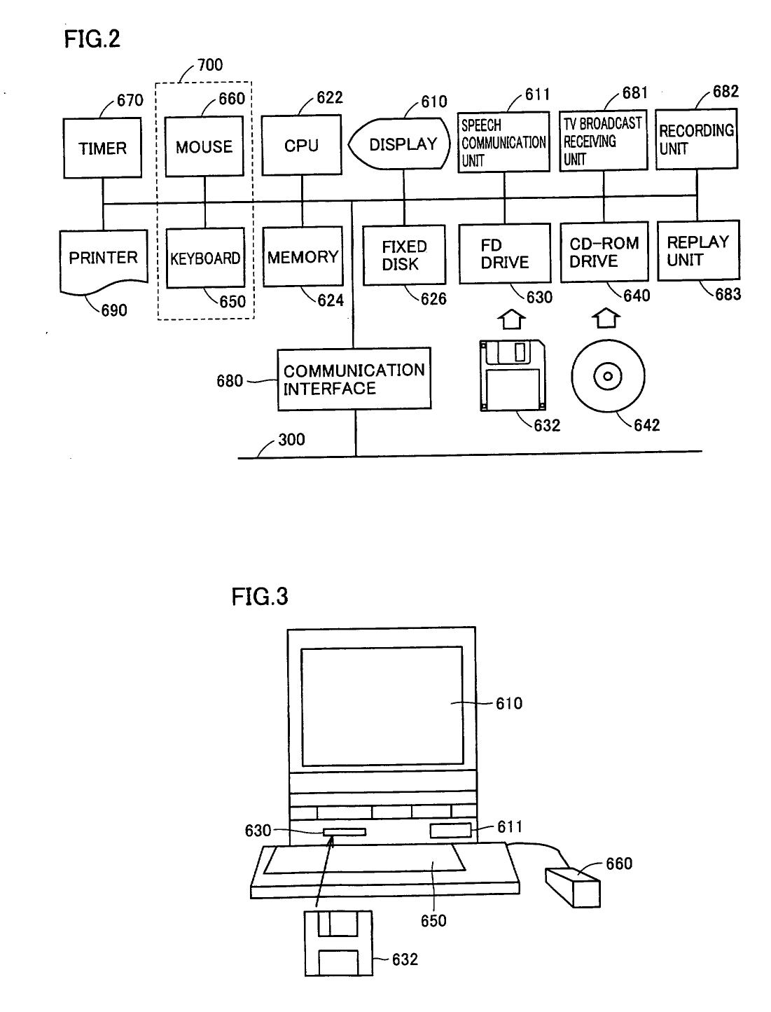

FIG. 1 shows a schematic configuration of a communication system having a conversation device according to the present embodiment. Each of FIGS. 2 and 3 shows a configuration of a computer having the conversation device according to the present embodiment mounted thereon. FIG. 2 shows a block configuration of the computer, while FIG. 3 shows an outward appearance of the computer. Although the conversation device is herein shown as a desktop type, it may be a portable type terminal.

Referring to FIGS. 2 and 3, the computer includes a display 610 formed of a cathode-ray tube (CRT), liquid crystals or the like, a speech communication unit 611 formed of a microphone, a loudspeaker or the like, an input unit 700 having a keyboard 650 and a mouse 660, a CPU (a central processing unit) 622, a memory 624 configured to include a Read Only Memory (ROM) or a Random Access Memory (RAM), a fixed disk 626 formed of an HDD, for example, an FD drive 630 accessing a flexible disk (FD) 632 detachably attached thereto, a Compact Disk Read Only Memory (CD-ROM) drive 640 accessing a CD-ROM 642 detachably attached thereto, a timer 670 for timing, a communication interface 680 for establishing a communication link between a communication network 300 and the computer, a television (TV) broadcast receiving unit 681, a recording unit 682, a replay unit 683, and a printer 690. Communication links are established among these units through a bus. The computer may be provided with a magnetic tape device accessing a cassette-type magnetic tape detachably attached thereto.

Communication network 300 is a wired or wireless (including an optical medium such as infrared ray) communication line, and includes an Internet.

Based on an instruction from CPU 622, TV broadcast receiving unit 681 receives a TV broadcast signal on a specified channel, converts the signal into digital information such that the signal can be processed, and outputs the digital information. Recording unit 682 stores (records), in a prescribed region of fixed disk 626, a TV broadcast program content received and output by TV broadcast receiving unit 681, a content externally input through communication network 300, or a content read from FD 632 and CD-ROM 642.

Based on an instruction from CPU 622, replay unit 683 reads the specified content from fixed disk 626 so as to replay the same. The read content is displayed through display 610.

(Configuration)

Referring to FIG. 1, there are connected, in the system, first and second conversation devices 101 and 201 (hereinafter referred to as conversation devices 101 and 201) mounted on the computers as shown in FIGS. 2 and 3, first and second Electric Program Guide (EPG) managing site 302 and 304 (hereinafter referred to as EPG managing sites 302 and 304), each of which is a computer having a database, retrieving data stored in the database in response to a request, and transmitting (providing) the data to a requestor, and first and second CD Data Base (CDDB) managing sites 303 and 305 (hereinafter referred to as CDDB managing sites 303 and 305), through communication network 300. Such devices communicate with each other through communication network 300. Although two conversation devices are provided in the present embodiment, three or more conversation devices may be provided. Furthermore, although two EPG managing sites and two CDDB managing sites are provided, one or more EPG managing site(s) and one or more CDDB managing site(s) may be connected.

EPG managing sites 302 and 304 store data showing a broadcast channel, a program title, a broadcast date (including a time slot), a broadcast region, and a comment on the content of a TV program (content) broadcasted from a broadcast station, so that they read the data on the requested TV program and transmit the same to a requester.

CDDB managing sites 303 and 305 store data showing a title of a commercially-available CD (content) and a comment on a tune stored therein, so that they read the data on the requested CD and transmit the same to a requestor.

Conversation device 101 or conversation device 201 can access (communicate with) any of EPG managing sites 302 and 304, and accessible to any of CDDB managing sites 303 and 305. For convenience in explanation, however, assume that conversation device 101 accesses EPG managing site 302 and CDDB managing site 303, while conversation device 201 accesses EPG managing site 304 and CDDB managing site 305.

Conversation device 101 has a TV telephone 102 and a content storing unit 103, while conversation device 201 has a TV telephone 202 and a content storing unit 203. Each of TV telephones 102 and 202 includes a display 610 and a speech communication unit 611, so that a user can hold conversation with another user through communication network 300 by means of speech communication unit 611, and additionally, check the content presented (displayed) on display 610 or output (presented) as voice from a loudspeaker in speech communication unit 610. The TV telephone is what is called a video phone.

Each of content storing units 103 and 203 corresponds to a prescribed region of fixed disk 626, and can store at least one content. Here, content storing unit 103 stores a TV broadcast recorded content 1041, which are information obtained by recording a TV broadcast program, and a CD content 1051, which are information on a sound (a voice and a tune) downloaded from a prescribed site (not shown) providing a tune or transferred from a CD. Similarly, content storing unit 203 stores a TV broadcast recorded content 2041 and a CD content 2051.

Although content storing units 103 and 203 are herein embedded in conversation devices 101 and 201, respectively, they may be mounted to an external device connected to conversation devices 101 and 201 through communication network 300 or through dedicated, wired or wireless (including an optical communication path such as infrared ray) connection.

Each of content storing units 103 and 203 may be configured with a plurality of independent storage units, instead of being a single piece. In that case, the plurality of storage units are connected with each other via a communication function such as a network and form a single content storing unit.

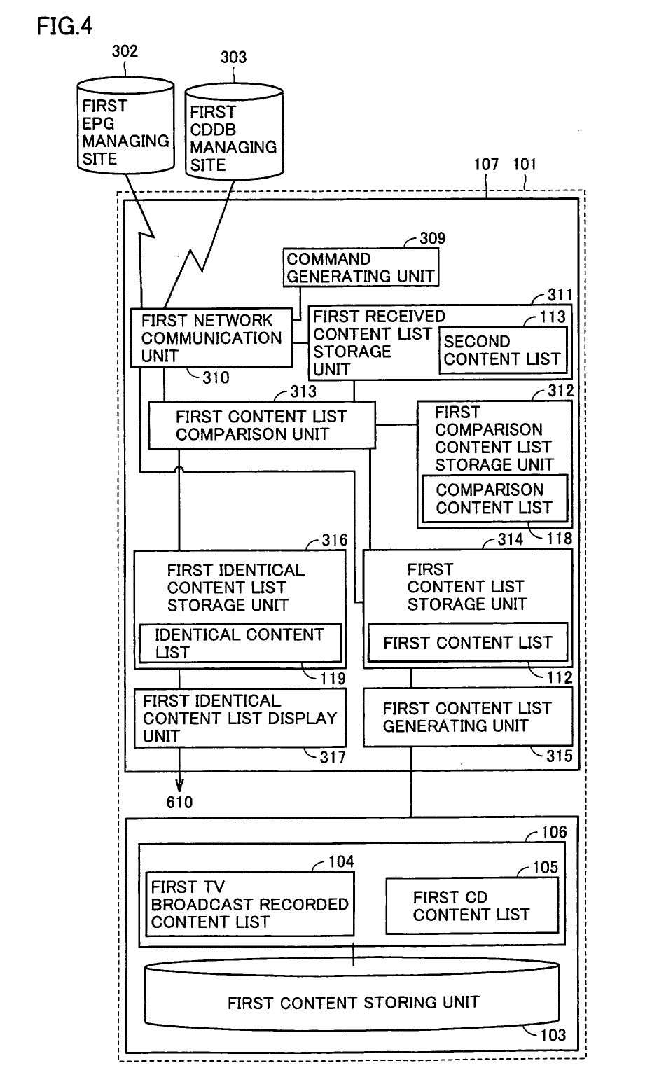

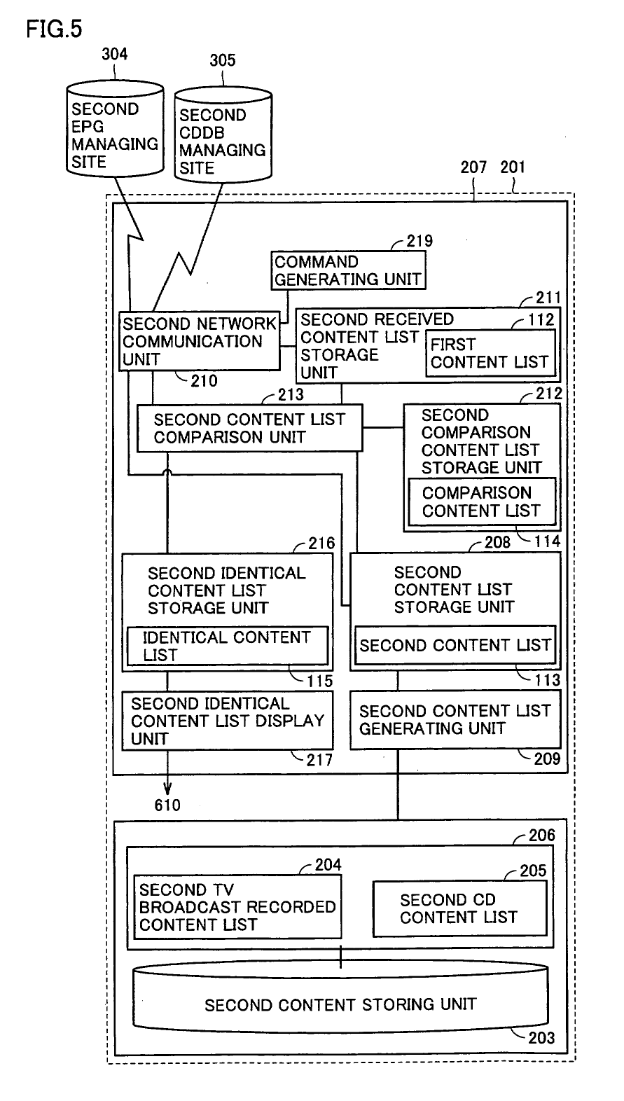

FIGS. 4 and 5 show functional configurations of conversation devices 101 and 201, respectively. Both devices have similar functional configurations. Conversation device 101 includes a first content list managing unit 107 (hereinafter referred to as content list managing unit 107), a first content managing unit 106 (hereinafter referred to as content managing unit 106), and first content storing unit 103 (hereinafter referred to as content storing unit 103). Content list managing unit 107 has a command generating unit 309 for generating an identical viewing and listening command CM, described below, for allowing the same operation to be performed in both of the conversation devices with regard to the selected content, a first network communication unit 310 (hereinafter referred to as network communication unit 310) for communicating with external units such as EPG managing site 302, CDDB managing site 303, and conversation device 201, through communication network 300, a first received content list storage unit 311 (hereinafter referred to as received content list storage unit 311) for storing a second content list 113 (hereinafter referred to as content list 113), a first comparison content list storage unit 312 (hereinafter referred to as comparison content list storage unit 312) for storing comparison content list 118, a first content list comparison unit 313 (hereinafter referred to as content list comparison unit 313), a first content list storage unit 314 (hereinafter referred to as content list storage unit 314) for storing a first content list 112 (hereinafter referred to as content list 112), a first content list generating unit 315 (hereinafter referred to as content list generating unit 315), a first identical content list storage unit 316 (hereinafter referred to as identical content list storage unit 316) for storing an identical content list 119, and a first identical content list display unit 317 (hereinafter referred to as identical content list display unit 317) for presenting (displaying) identical content list 119 on display 610.

Content managing unit 106 has a first TV broadcast recorded content list 104 (hereinafter referred to as TV broadcast recorded content list 104) and a first CD content list 105 (hereinafter referred to as CD content list 105).

In the case where conversation device 101 is shared by a plurality of users, content managing unit 106 has TV broadcast recorded content list 104 and CD content list 105 which correspond to each of the users. When a user to utilize conversation device 101 is specified, TV broadcast recorded content list 104 and CD content list 105 corresponding to the user are uniquely determined. Accordingly, the following description can similarly be applied to such a case where a single conversation device is shared by a plurality of users.

Conversation device 201 includes a second content list managing unit 207 (hereinafter referred to as content list managing unit 207), a second content managing unit 206 (hereinafter referred to as content managing unit 206), and a second content storing unit 203 (hereinafter referred to as content storing unit 203). Content list managing unit 207 has a command generating unit 219 for generating identical viewing and listening command CM (i.e., a command for allowing users to view and listen the identical content), a second network communication unit 210 (hereinafter referred to as network communication unit 210) for communicating with external units such as EPG managing site 304, CDDB managing site 305, and conversation device 101 through communication network 300, a second received content list storage unit 211 (hereinafter referred to as received content list storage unit 211) for storing first content list 112, a second comparison content list storage unit 212 (hereinafter referred to as comparison content list storage unit 212) for storing a comparison content list 114, a second content list comparison unit 213 (hereinafter referred to as content list comparison unit 213), a second content list storage unit 208 (hereinafter referred to as content list storage unit 208) for storing a second content list 113 (hereinafter referred to as content list 113), a second content list generating unit 209 (hereinafter referred to as content list generating unit 209), a second identical content list storage unit 216 (hereinafter referred to as identical content list storage unit 216) for storing an identical content list 115, and a second identical content list display unit 217 (hereinafter referred to as identical content list display unit 217) for displaying identical content list 115 on display 610.

Content managing unit 206 has a second TV broadcast recorded content list 204 (hereinafter referred to as TV broadcast recorded content list 204) and a second CD content list 205 (hereinafter referred to as CD content list 205).

Conversation devices 101 and 201 establish communication (conversation) therebetween through network communication units 310 and 210 corresponding to communication interface 680, via communication network 300.

TV broadcast recorded content 1041 and 2041 in content storing units 103 and 203, respectively, are a TV program, for example, received by TV broadcast receiving unit 681 and recorded by recording unit 682. TV broadcast recorded content lists 104 and 204 are generated in accordance with the information received from EPG managing sites 302 and 304 with regard to TV broadcast recorded content 1041 and 2041, respectively. Furthermore, CD contents 1051 and 2051 in content storing units 103 and 203, respectively, are data, for example, read from CD-ROM 642 and stored. CD content list 105 is generated in accordance with the information received from CDDB managing site 303 with regard to CD content 1051, while CD content list 205 is generated in accordance with the information received from CDDB managing site 305 with regard to CD content 2051.

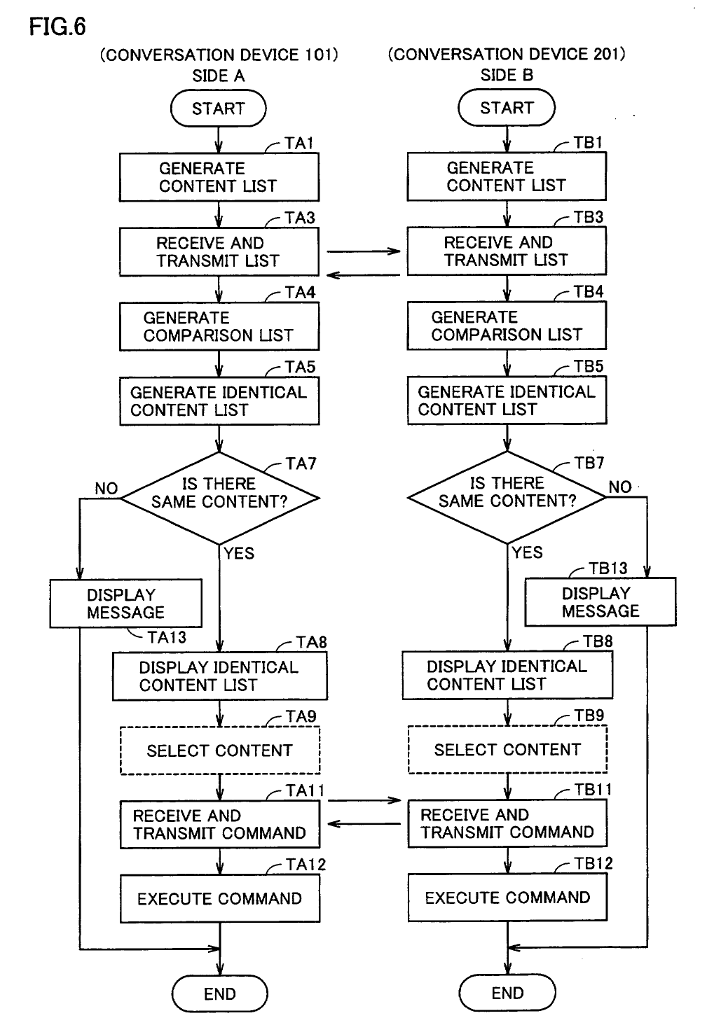

Referring to the configurations in FIGS. 4 and 5, there is described a method of generating identical content lists 119 and 115 in accordance with the procedure in FIG. 6. Assume that conversation device 101 in FIG. 4 is a device of a user A, while conversation device 201 is a device of a user B, and that users A and B establish communication (conversation) therebetween through conversation devices 101 and 201. A program shown in each of the flowcharts described below including FIG. 6, is stored in advance in memory 624 of each of the conversation devices. CPU 622 reads the program from memory 624 and executes the same, so that the process according to each of the flowcharts is implemented.

Initially, content list generating unit 315 in conversation device 101 generates content list 112, based on information in TV broadcast recorded content list 104 and CD content list 105 read from content managing unit 106 (step TA1). Similarly, content list generating unit 209 in conversation device 201 generates content list 113, based on information in TV broadcast recorded content list 204 and CD content list 205 read from content managing unit 206 (step TB1). As described above, TV broadcast recorded content lists 104 and 204 are generated in accordance with the information from the different EPG managing sites, and CD content lists 105 and 205 are also generated in accordance with the information from different CDDB managing sites. Accordingly, even if content lists 112 and 113 include information on the same content, the information in content list 112 and the information in content list 113 may be different, even with regard to the same content.

The generated content lists 112 and 113 are stored in content list storage units 314 and 208, respectively, and are read therefrom and transmitted to the other conversation devices through network communication units 310 and 210, respectively, via communication network 300 (steps TA3 and TB3).

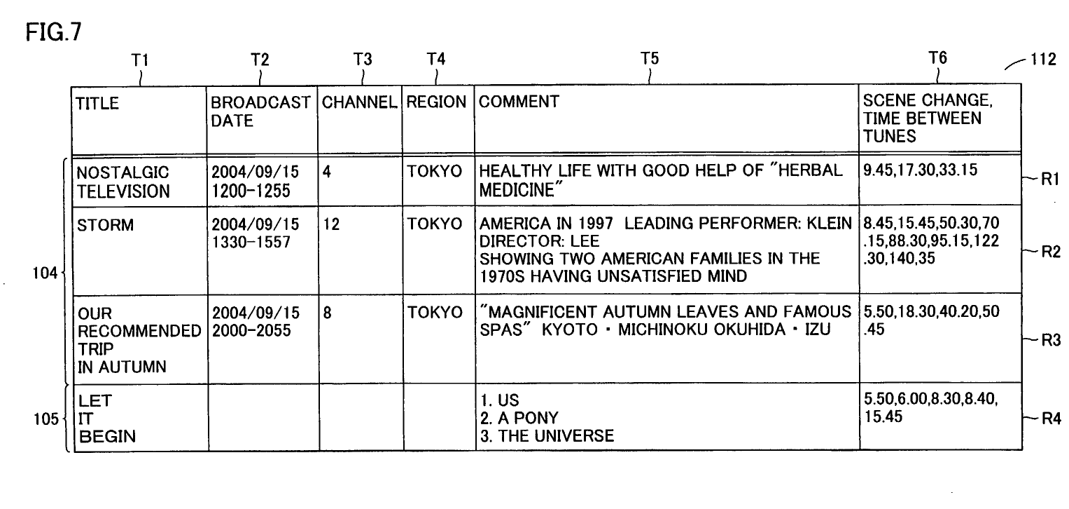

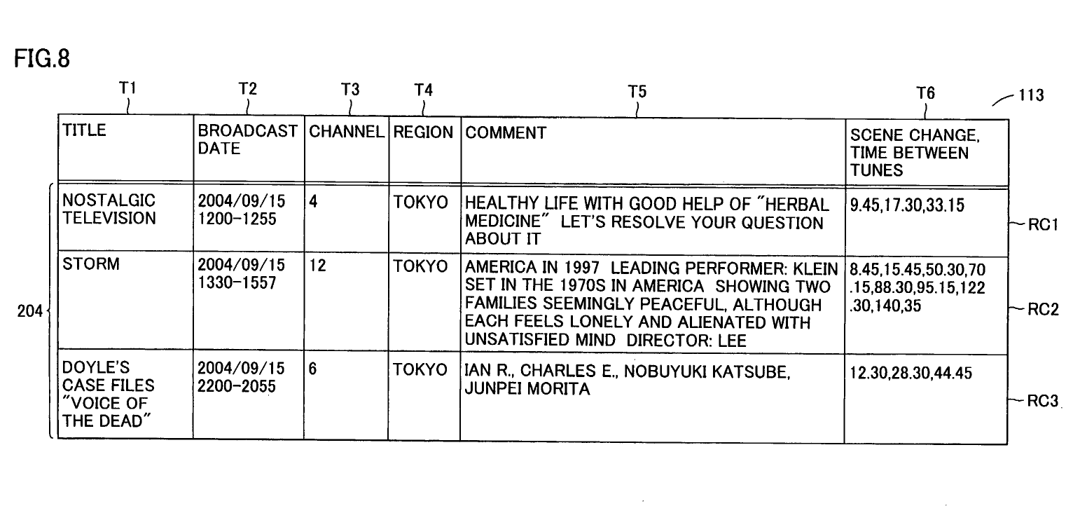

Examples of the generated content lists 112 and 113 are shown in FIGS. 7 and 8, respectively. Referring to FIG. 7, content list 112 has a record Ri (i=1, 2, 3 . . . ) corresponding to one content or has records Ri corresponding to a plurality of contents on one-to-one basis, and record Ri contains data in items T1-T6. Referring to FIG. 8, content list 113 has a record RCi (i=1, 2, 3 . . . ) corresponding to one content or has records RCi corresponding to a plurality of contents on one-to-one basis, and record RCi contains data in items T1-T6. Items T1-T6 includes information which relates to the corresponding contents, and with which the corresponding contents can be specified.

It is possible in content lists 112 and 113 to determine whether or not records Ri and RCi are a record of a TV broadcast program content, based on whether or not records Ri and RCi have data in item T3, which data indicates a channel. Each of records Ri and RCi may contain data on a content type indicating that the information in the record is intended for a TV broadcast program, a tune in a CD and the like, or a movie in a DVD and the like. In that case, based on the type described above, it is possible to determine whether or not the record refers to a record of a TV broadcast program content.

The data in records R1, R2 and R3 in content list 112 refers to the content read from TV broadcast recorded content list 104, while record R4 refers to the content read from CD content list 105. It is assumed herein that no information is registered in CD content list 205. Accordingly, all the records RCi in content list 113 show the content read from TV broadcast recorded content list 204.

Data in item T1 shows a title of the corresponding content (a TV program, a tune or the like), data in item T2 shows a broadcast date and a time slot of the corresponding content (the TV program), data in item T3 shows a specified broadcast channel of the corresponding content (the TV program), data in item T4 shows a specified region where the corresponding content (the TV program) is broadcasted, data in item T5 shows information on a comment as to the content, which information is obtained from the EPG (or CDDB) of the corresponding content (a title of a tune, a performer, a musical performer, an introductory comment on a program, and the like), and data in item T6 shows a series of times when a scene change occurs (or time intervals for which a tune continues or pauses (times between a tune)) in a list form (hereinafter referred to as an elapsed time list).

The scene change shown by the elapsed time list in item T6 is a timing at which a display is switched, and the timing can easily be detected based on the fact that a motion vector of an image is interrupted between adjacent frames. This function of detecting the timing is generally embedded in a DVD recorder or the like, and is used for generating a header in recorded program content.

Although not shown, each of the records in content lists 112 and 113 stores data (an address) indicating a location where the corresponding content is stored. Accordingly, when the title of the content in item T1 is specified, it is possible to search the corresponding record and read the address, and access (read) the content based on the read address.

In the case of TV broadcast recorded content in the present embodiment, at the time when recording is scheduled, information on the content to be recorded is stored in TV broadcast recorded content list 104 or 204, and at the same time, content list 112 or 113 are generated based on the stored information in TV broadcast recorded content list 104 or 204. The elapsed time list in item T6 is generated by content managing unit 106 when an additional content is stored in content storing unit 103 in conversation device 101, and stored in the corresponding record in TV broadcast recorded content list 104 or CD content list 105. Similarly, the elapsed time list in item T6 is generated in conversation device 201 by content managing unit 206 when an additional content is stored in content storing unit 203, and stored in the corresponding record in TV broadcast recorded content list 204 or CD content list 205.

It is also possible to store, in content storing unit 103 or 203, a movie content downloaded from a prescribed site or transferred from a DVD. In that case, the content list of the movie content has a content similar to that of the lists of a music content. However, instead of the data on time intervals for which a tune continues or pauses, an elapsed time list for the scene change is shown in item T6.

When network communication unit 310 in conversation device 101 transmits content list 112 read from content list storage unit 314 to conversation device 201, to which communication is established, network communication unit 210 in conversation device 201 receives content list 112 and stores the received content list 112 in received content list storage unit 211. Similarly, network communication unit 210 in conversation device 201 transmits content list 113 read from content list storage unit 208 to conversation device 101, to which communication is established, network communication unit 310 in conversation device 101 receives content list 113 and stores the received content list 113 in received content list storage unit 311.

Content lists 112 and 113 are transferred under the information transmission procedure such as e-mail, a file transfer protocol (ftp), and a session initiation protocol (SIP). In this case, the content list may initially be encrypted and then transferred. When the content list is transferred by e-mail, content list 112 (113) is transmitted by being described in a mail text, or being attached to mail as a document, and is reproduced on the receiving end. When the content list is transferred by the ftp, content list 112 (113) is transferred in a file.

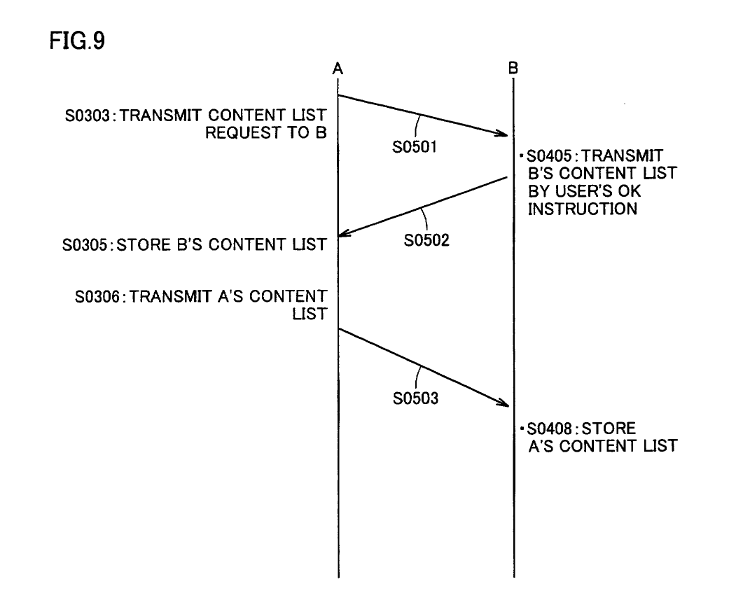

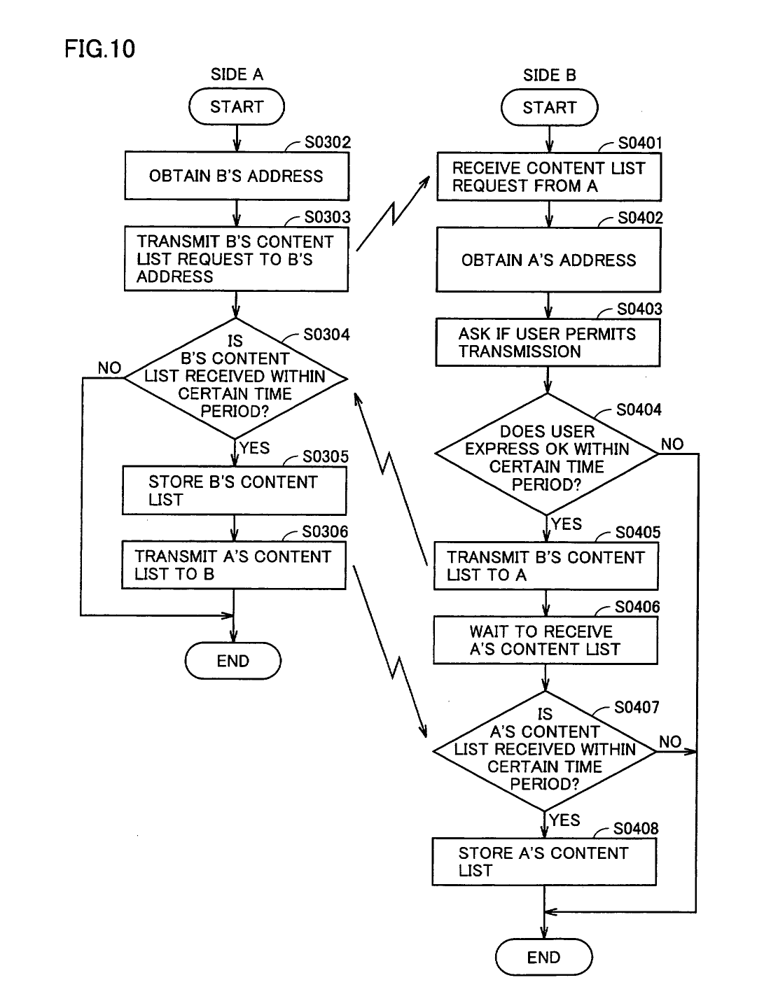

The transfer of content lists 112 and 113 by the SIP will be described with reference to FIGS. 9 and 10. FIG. 9 schematically shows the flow (reception and transmission) of a signal between the conversation devices of user A and user B, whom user A holds conversation with. FIG. 10 shows, on its left side, a flowchart of a process performed in conversation device 101 of user A, and shows, on its right side, a flowchart of a process performed in conversation device 201 of user B.

Initially, in step S0501 in FIG. 9, based on an instruction from user A through keyboard 650, for example, CPU 622 transmits a content list transfer request to conversation device 201 of user B through network communication unit 310 in conversation device 101 (step S0303). At that time, network communication unit 310 searches an address book table or the like, not shown, stored in advance in memory 624, for example, and obtains an address of conversation device 201 (step S0302). The transfer request is therefore transmitted to the obtained address.

When network communication unit 210 in conversation device 201 receives the transfer request (step S0401), it obtains an address of conversation device 101 (step S0402). The address is obtained by, for example, reading an address of the transmitting end added to a header or the like of the received transfer request.

When the transfer request is received, CPU 622 in conversation device 201 outputs a message asking if user B permits transmission of the content list, through display 610 or a loudspeaker (not shown) in speech communication unit 611 (step S0403). CPU 622 determines whether an instruction of transfer “OK” is input by the user through keyboard 650 or the like, within a certain time period after the message is output, which time period is measured by timer 670 (step S0404). Assume that the data showing the certain time period is stored in advance in memory 624. If it is determined that the instruction of “OK” is not input by the user within the certain time period (NO in step S0404), a series of processes terminates, so that content list 113 in conversation device 201 is not transmitted to conversation device 101.

In contrast, if user B inputs the instruction of OK within the certain time period (YES in step S0404), CPU 622 reads content list 113 from content list storage unit 208 and provides the content list to network communication unit 210, so that network communication unit 210 transmits the provided content list 113 to the address of conversation device 101 (steps S0405 and S0502).

CPU 622 in conversation device 101 determines whether or not content list 113 is received from network communication unit 210 in conversation device 201 within a certain time period after the transfer request is transmitted, which time period is measured by timer 670 (step S0304). If the content list is not received within the certain time period (NO in step S0304), a series of processes terminates. If the content list is received within the certain time period (YES in step S0304), the received content list 113 is stored in received content list storage unit 311 (step S0305). Content list 112 is then read from content list storage unit 314 and transmitted to conversation device 201 by network communication unit 310 (steps S0306 and S0503), and the process terminates.

Network communication unit 210 in conversation device 201 waits to receive the content list from conversation device 101 within a certain time period after network communication unit 210 transmits the content list to conversation device 101 (step S0406). If network communication unit 210 cannot receive the content list within the certain time period (NO in step S0407), a series of processes terminates. If network communication unit 210 receives the content list within the certain time period (YES in step S0407), it stores the received content list 112 in received content list storage unit 211, and the process terminates.

Returning to FIG. 6, in order to perform a process for generating an identical content list, which shows an identical content contained in both of the received content list and the self-made content list, in each of conversation devices 101 and 201 (processes in steps TA5 and TB5 described below), comparison content lists 118 and 114 are generated by content list comparison units 313 and 213 and stored in comparison content list storage units 312 and 212, respectively, in steps TA4 and TB4. In other words, the content list received from the other conversation device and the content list generated in its own conversation device are generated in accordance with the information from different EPG managing sites or different CDDB managing sites, and hence the information pieces, which show the content of a single TV broadcast program and are indicated by the data in item T5 in the corresponding records Ri and RCi, may be different from each other, even with regard to the same content. Accordingly, the information pieces on the same TV broadcast program in item T5 in records Ri and RCi are updated to match with each other, and thereby comparison content lists 118 and 114 are generated such that the content lists can be compared with each other.

In conversation device 201, content list comparison unit 213 reads content list 112 from received content list storage unit 211, and reads data on a broadcast date, a broadcast channel, and a broadcast region shown by items T2, T3 and T4, respectively, with regard to each record Ri of a TV broadcast program content, so as to provide the data to network communication unit 210. Network communication unit 210 communicates with EPG managing site 304, and transmits a request for information on the content corresponding to the data provided by content list comparison unit 213. When EPG managing site 304 receives the request, it searches the stored EPG information based on the data on a broadcast date, a broadcast channel, and a broadcast region, which data is received with the request, so that the EPG data on each of the corresponding contents (data on a title, a broadcast date, a broadcast channel, and a broadcast region of the contents, and a comment on the contents) is read therefrom and transmitted back to network communication unit 210. Network communication unit 210 provides the received data to content list comparison unit 213, so that content list comparison unit 213 generates comparison content list 114 based on the provided data, and stores the same in comparison content list storage unit 212. A similar procedure is also carried out in conversation device 101. Comparison content list 118 is generated by communication with EPG managing site 302 with the use of content list 113, and stored in content list storage unit 312.

Returning to FIG. 6, in steps TA5 and TB5, the content of the comparison content list and the content of the self-made content list are compared, and based on a comparison result, identical content list is generated in each of the conversation devices.

In conversation device 101, content list comparison unit 313 compares the information in content list 112 read from content list storage unit 314, and the information in comparison content list 118 read from comparison content list storage unit 312, and based on a comparison result, identical content list 119 is generated and stored in identical content list storage unit 316 (step TA5). Similarly, in conversation device 201, content list comparison unit 213 compares the information in content list 113 read from content list storage unit 208, and the information in content list 114 read from comparison content list storage unit 212, and based on a comparison result, identical content list 115 is generated and stored in identical content list storage unit 216 (step TB5).

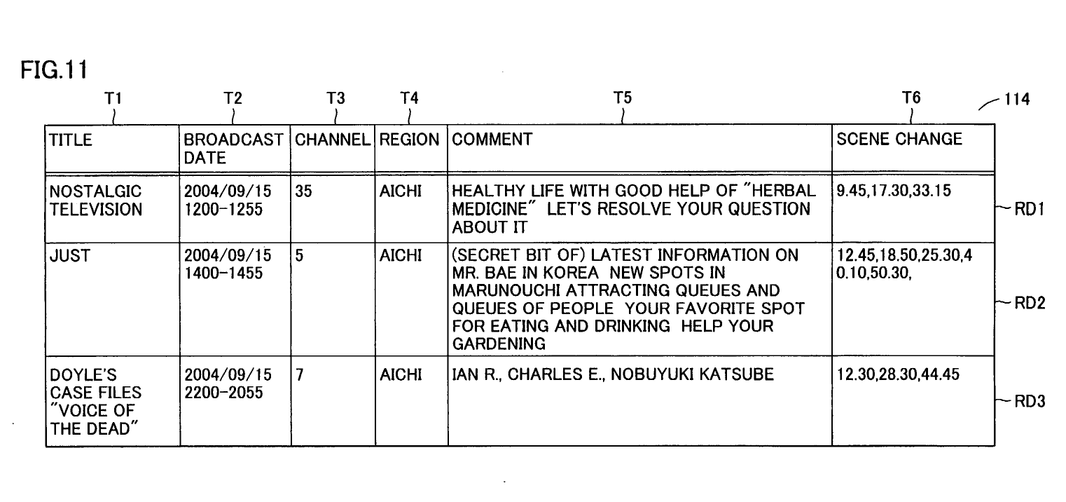

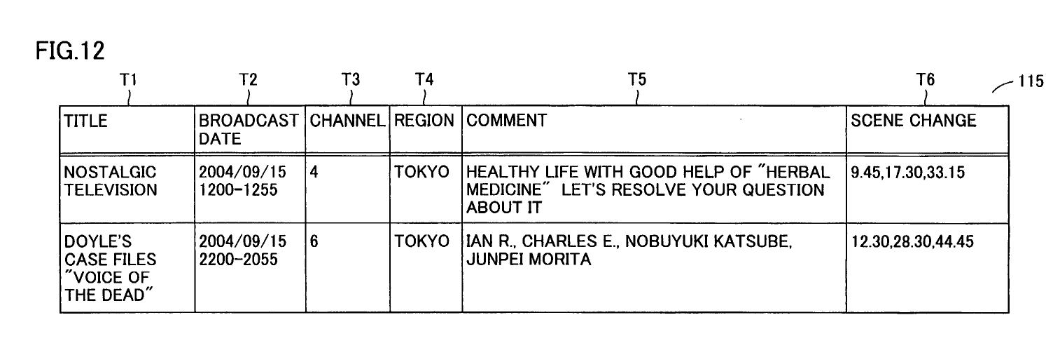

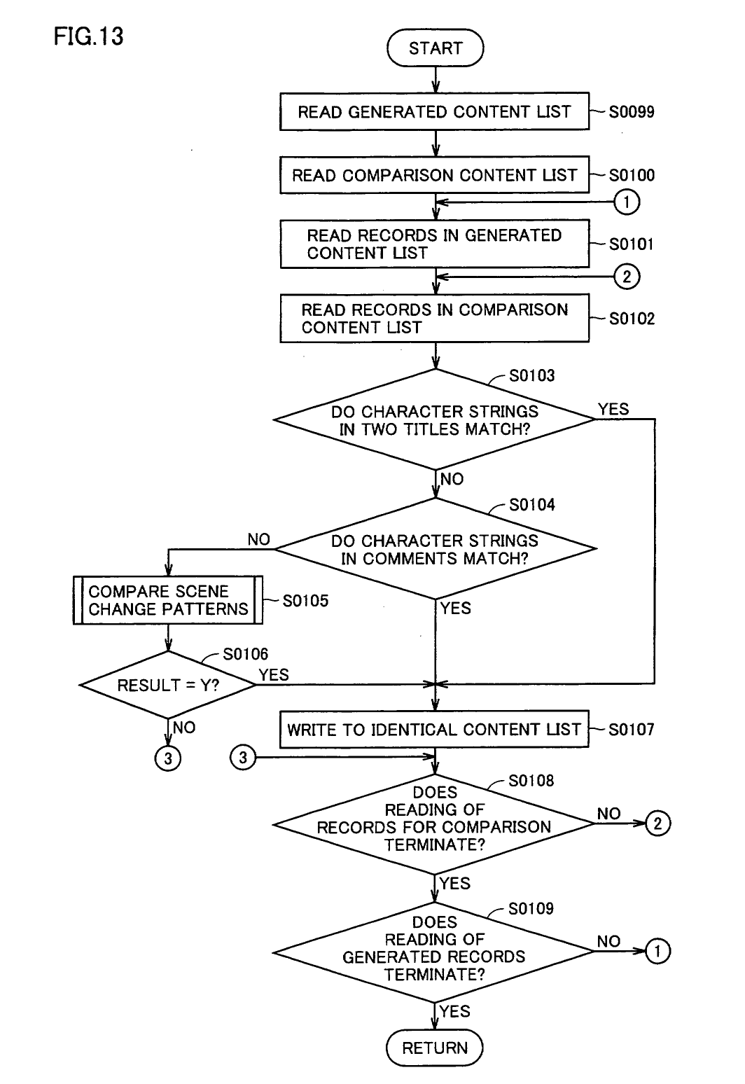

The process flowchart in steps TA5 and TB5 is shown in FIG. 13. The procedure in FIG. 13 is carried out in both of conversation devices 101 and 201, and hence explanation will be made taking conversation device 201 as an example. Assume that a list shown in FIG. 11 refers to comparison content list 114, and that identical content list 115 shown in FIG. 12 is to be generated. Comparison content list 114 in FIG. 11 has a record RDi containing data in items T1-T6, in a manner corresponding to the content.

A broadcast date and a comment as well as a broadcast channel in the EPG may vary depending on a broadcast region. Accordingly, content list 112 in FIG. 7 and comparison content list 114 in FIG. 11 are different in broadcast date, channel, and broadcast region.

Here, the elapsed time list shown by item T6 in comparison content list 114 can be recorded as follows. For example, assume the case where the content is an image. In a top frame image in a scene, most blocks are not similar to the corresponding blocks in a frame just before the top frame image, and instead, similar to the corresponding blocks in a frame just after the top frame image. Three time-series frame images are extracted from a video picture, and similarities of all the corresponding blocks therein are calculated with the use of a color histogram to detect a scene change, and record a time period from the top to the time point at which the scene change occurs. Furthermore, in the case where the content corresponds to a music CD, a time length of a tune and a time length of a blank are recorded in the form of a digit string.

Referring to FIG. 13, content list comparison unit 213 initially reads content lists 113 and 114 from content list storage unit 208 and comparison content list storage unit 212, respectively (steps S0099 and S0100), compares each record RCi of a TV broadcast program in the read content list 113 and the information in each record RDi of a TV broadcast program in comparison content list 114, and generates identical content list 115 based on a comparison result.

Specifically, and initially, the first record RCi of a TV broadcast program in content list 113 is read (step S0101), and the first record RDi in comparison content list 114 is read (step S0102). Titles shown by data in item T1 in the two read records RCi and RDi are compared (step S0103). The titles are compared by the comparison between character strings in the titles. When character strings are compared, a character string “re” or “rebroadcast” in the title is excluded from a target of comparison.

After the titles are compared, if it is determined that the titles match (the character strings match) (YES in step S0103), the record RCi is written to a region for identical content list 115 in memory 624 (step S0107).

Subsequently, in order to determine whether the comparison should further be continued, it is determined whether all the records RDi are read from comparison content list 114. If all the records RDi are completely read (YES in step S0108), it is then determined whether all the records RCi are read from content list 113. If all the records RCi are completely read (YES in step S0109), the process for generating identical content list 115 terminates, so that the procedure returns to the processes in FIG. 6.

If it is determined that not all the records RDi are read from comparison content list 114 (NO in step S0108), the procedure returns to step S0102, the next record RDi is read from comparison content list 114, and the subsequent process is similarly performed. If it is determined that not all the records RCi are read from content list 113 (NO in step S0109), the procedure returns to the process in step S0101, the next record RCi is read from content list 113, and the subsequent process is similarly performed.

If it is determined that the titles (character strings) do not match (NO in step S0103), content list comparison unit 313 compares character strings of an introduction and a comment of the program content, shown by the data in item T5 in records RDi and RCi (step S0104). If it is determined that the character strings match (YES in step S0104), the process in step S0107 and the following steps are similarly performed. If it is determined that the character strings do not match (NO in step S0104), the procedure proceeds to the process in step S0105 described below.

As a method of comparing character strings, steps S0103 and S0104 adopt a method of perfect matching between the character strings. As an example, however, if the character strings are divided into words, and at least 80% of noun words thereof match with each other, the character strings may be determined as “match”. For example, the character string in item T5 in record RD3 in comparison content list 114 do not completely match with the character string in item T5 in record RC3 in content list 113. However, according to the condition in which at least 80% of the noun words should match with each other, both of the character strings are determined as “match”, and hence record RC3 is stored in identical content list 115 in FIG. 12.

Such a criterion for determination may be modified in accordance with the EPG information registered in the EPG managing sites or the CDDB information registered in the CDDB managing sites.

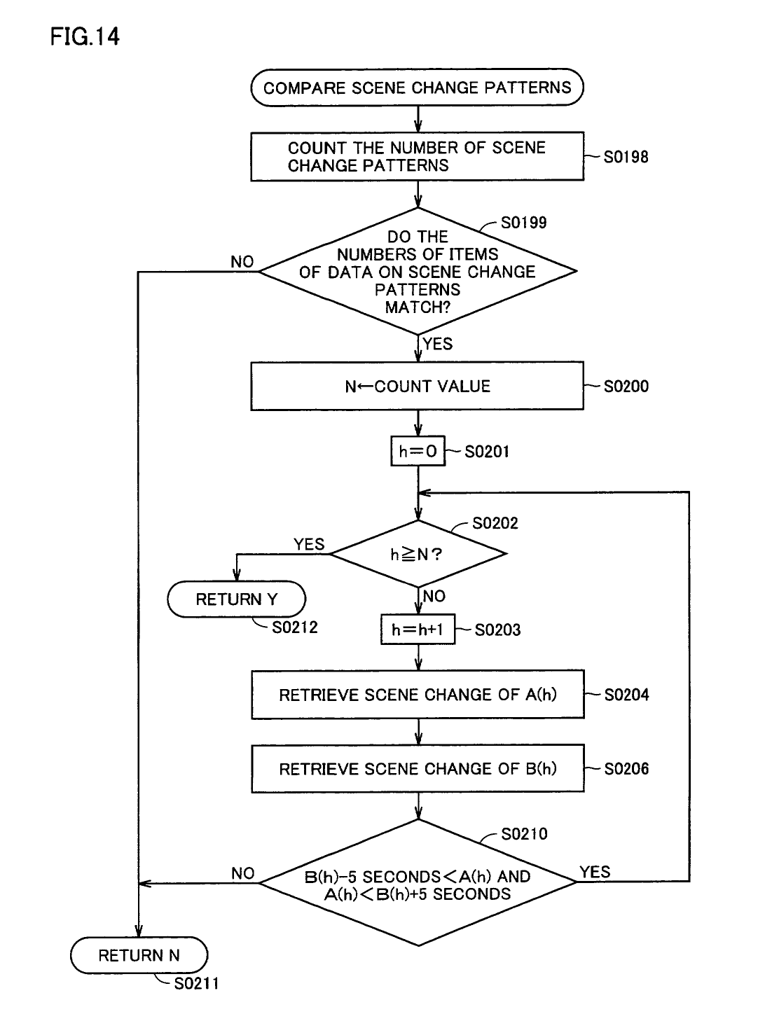

In step S0105, the scene change elapsed times shown by the data in item T6 in records RCi and RDi are compared according to the procedure in FIG. 14.

Referring to FIG. 14, there is initially counted the number of items of scene change data shown by times (minute. second) delimited by “,” in the scene change elapsed times shown by the data in item T6 in each of records RCi and RDi (step S0198). Assume that at least one item of scene change data is included in item T6. It is then determined whether or not the count values for both of the records match (step S0199). If it is determined that they do not match (NO in step S0199), a returned value is set to “N”, which indicates mismatch, in the process in step S0211, and the procedure returns to the former process.

If it is determined that the count values match (YES in step S0199), a variable N is set to the count value (step S0200), and a variable h, which controls the processes, is set to zero by default (step S0201). Variable h serves as a variable for counting the number of scene change data items in item T6, and is sequentially count up by one in the processes. Accordingly, it is determined in step S0202 whether or not the value of variable h reaches or exceeds the value of variable N. If it is determined that the value reaches or exceeds the value of variable N (YES in step S0202), the procedure proceeds to the process in step S0212, and a returned value is set to “Y”, which indicates “match”, so that the procedure returns to the former process. In contrast, if it is determined that the value of variable h does not reach or exceed the value of variable N (NO in step S0202), the value of variable h is incremented by one (step S0203), so that the procedure proceeds to the process in step S0204.

In the following description, each scene change data item in item T6 in record Ri is specified as A(h), while each scene change data item in item T6 in record RDi is specified as B(h).

Next, scene change data A(h) and B(h) are retrieved (extracted) from records RCi and RDi, respectively (step S0204). The times (minute. second) shown by the retrieved two scene change data items A(h) and B(h) are compared, and it is determined whether a difference between them is less than five seconds (step S0210). If it is determined that the difference is less than five seconds (YES in step S0210), the procedure proceeds to the process in step S0202. If it is determined that the difference is at least five seconds (NO in step S0210), the procedure proceeds to the process in step S0211. Although the criterion for determination in step S0210 is set to five seconds, the criterion is not limited thereto.

Here, detection is initially made in steps S0198, S0199 and S0202, by using the number of scene change data items. However, the detection process may not be performed. In that case, it is determined in the processes in step S0204 and step S0206 whether or not the scene change data is successfully retrieved. In other words, in the case where the value of variable h reaches or exceeds two, if one of scene change data A(h) and B(h) can be retrieved and the other of scene change data A(h) and B(h) cannot be retrieved, the numbers of scene change data items in records RCi and RDi do not match, and hence the process in step S0211 is performed. If both of the data items can be retrieved, the numbers of scene change data items in records RCi and RDi match (and determination as YES is obtained for all the scene change data in step S0210), and hence the process in step S0212 is performed.

Referring to the process in FIG. 13, when the scene change data comparison process in FIG. 14 (step S0105) terminates, it is determined in step S0106 whether or not a result of the process in step S0105 (returned value) indicates “Y” (match). If it is determined that the result indicates “Y” (YES in step S0106), the processes in step S0107 and the following steps are performed. If it is determined that the result does not indicate “Y”, in other words, indicates “N” (NO in step S0106), record RCi is not written to identical content list 115, and the processes in step S0108 and the following steps are performed.

Identical content list 115 in FIG. 12, which is generated through the above-described procedure, is stored in identical content list storage unit 216. If no record RCi is stored in identical content list 115, an identical content list is not generated, which means that there are no identical contents stored in both of conversation devices 101 and 201.

Similarly in conversation device 101, according to the procedures described in FIGS. 13 and 14, content list comparison unit 313 generates identical content list 119 based on the information in content list 112 and the information in comparison content list 118, and stores the generated identical content list 119 in identical content list storage unit 316.

Returning to FIG. 6, CPU 622 next determines in steps TA7 and TB7 whether or not there are identical contents, namely, whether or not identical content lists 119 and 115 are generated. If it is determined that there are no identical contents, in other words, identical content lists could not be generated (NO in step TA7, and NO in step TB7), a message indicating that there are no identical contents is output through display 610 or a loudspeaker in speech communication unit 611 (steps TA13 and TB13), and the process terminates.

In contrast, if it is determined that identical content list could be generated (YES in step TA7, and YES in step TB7), identical content lists 119 and 115 are read by identical content list display units 317 and 217 from identical content list storage units 316 and 216, respectively, and data based on the content of the read identical content lists is displayed on display 610 (steps TA8 and TB8). For example, it is desirable that at least a title and a comment in identical content list 115 in FIG. 12 are displayed. This allows each of users A and B to check the information on the contents that can simultaneously be viewed and listened by the user himself/herself and the other user to hold conversation with.

In the case of a content downloaded through the Internet in communication network 300, there is no information managing site. Accordingly, metadata attached to the content itself is utilized as a comment to be contained in the content list.

This is only an example of a method of generating identical content lists 115 and 119. The type of feature quantity to be referred to with regard to the content (a time length of a tune, a time length of blank, temporal information of a scene change) may be modified. Information to be utilized may be added or deleted. A step in an algorithm may be added or omitted. A criterion for determination in each step may be modified.

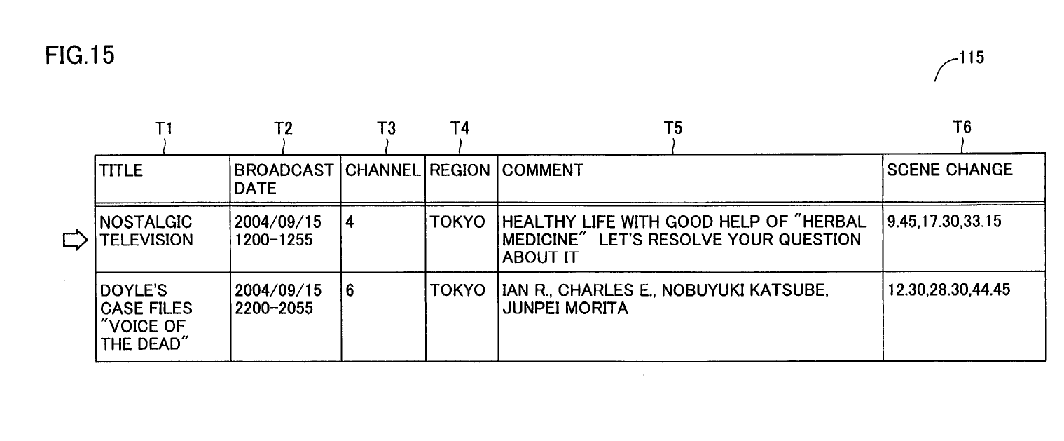

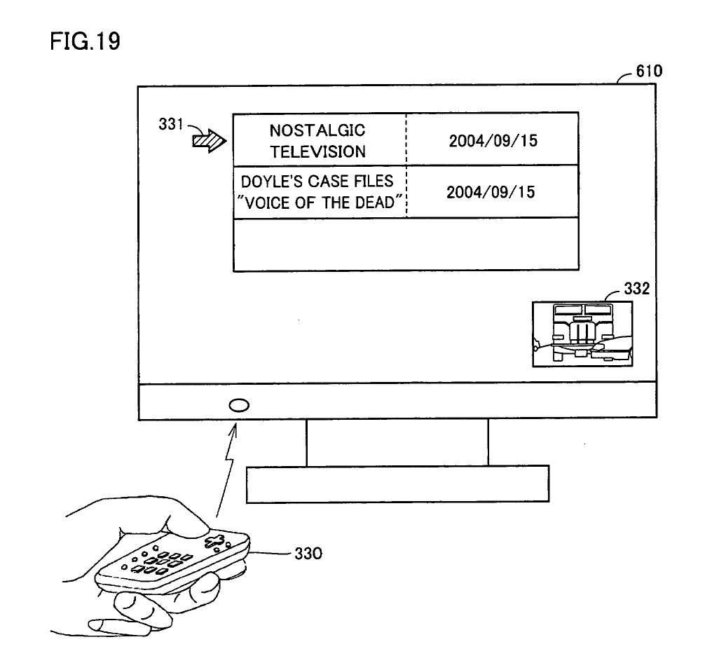

FIG. 19 shows how the identical content list is displayed and the desired content is selected. After the identical content list in FIG. 15 is displayed to one user and the other user as shown in FIG. 19, the users determine the content that would be a topic of their conversation. One of the users, such as user B, selects the information on one content in the displayed identical contents list 115, by manipulating a remote controller 330 at hand and using a cursor 331. Here, assume that user B of conversation device 201 selects the content indicated by cursor 331 in the displayed identical content list 115 in FIG. 15 (step TB9). Instead of user B, user A of conversation device 101 may select the content (step TA9).

In order that both of the users can view and listen the same scene of the selected content at conversation device 101 and conversation device 201, command generating unit 309 generates an identical viewing and listening command CM for replaying, at the same time instance, the same scene of the content selected by both of the users, based on an instruction input by user B through remote controller 331, and provides the identical viewing and listening command CM to network communication unit 310. Accordingly, network communication unit 310 transmits the provided identical viewing and listening command CM to conversation device 201 (step TB11). Keyboard 650 may be used instead of remote controller 331 in FIG. 19. Furthermore, a preview display 332 (see FIG. 19) of the selected content may be shown.

Identical view and listening command CM is a command for instructing an operation for similarly processing the selected content at both of the conversation devices, and there is used a type of identical viewing and listening command CM corresponding to the type of the operation.

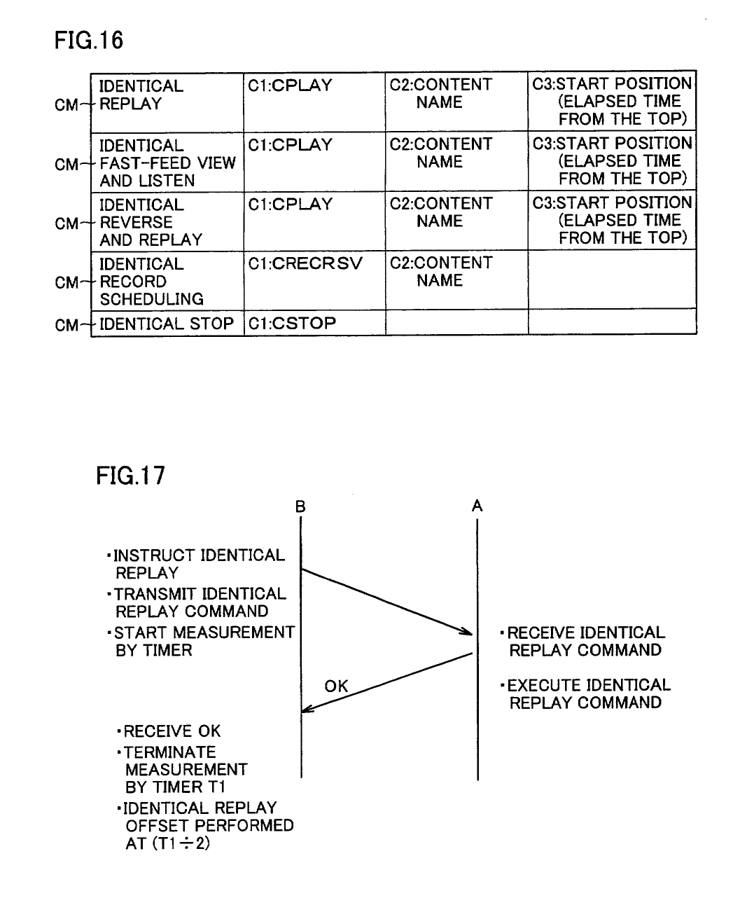

FIG. 16 shows, for example, five types of identical viewing and listening command CM. Identical viewing and listening command CM for instructing replay, fast-forward, rewind (reverse and replay) of the content includes a command C1 (replay: CPLAY, fast-forward: CFPLY, rewind: CRPLY) for instructing an operation to replay unit 683, a content name C2 for specifying the content to be replayed, and a start position C3 showing a position of the content specified by content name C2 from the top (an elapsed time from the start of recording), where the operation instructed by command C1 is to be initiated.

Furthermore, identical viewing and listening command CM for scheduling recording of the content includes a command C1 (CRECRSV) for instructing scheduling of recording, and content name C2 for indicating the content to be recorded.

Furthermore, identical viewing and listening command CM for stopping an operation includes a command C1 (CSTOP) for instructing a stop of an operation.

A character string code in identical viewing and listening command CM shown in FIG. 16 is communicated with the use of an identical procedure determined in both of the devices, such as a session initiation protocol (SIP), in reliance on a general communication function such as the Internet, a wireless apparatus such as a mobile telephone, or infrared communication.

Assume that identical viewing and listening command CM is transmitted from conversation device 201 (step TB11). Conversation device 101 on the other side receives the command through communication interface 680 (step TA11). CPU 622 interprets the character string code in the received identical viewing and listening command CM, and based on a result of interpretation, controls recording unit 682 or replay unit 683. Accordingly, recording unit 682 records, or schedules recording of, the TV broadcast program received through TV broadcast receiving unit 681. Alternatively, replay unit 683 searches content list 112, reads an address at which the content is stored, from a record corresponding to content name C2 in identical viewing and listening command CM, retrieves (reads) the content from a region specified by the address in content storing unit 103, so that the content is replayed in a mode according to command C1, from the position shown by start position C3 (step TA12).

Concurrently, similarly in conversation device 201, CPU 622 interprets the generated identical viewing and listening command CM. Based on a result of interpretation, content list 113 is searched as in the case of conversation device 101, and an address of the content specified by content name C2 is read. The content is searched for and read at the address in content storing unit 203, so that the content is replayed in a mode according to command C1, from the position shown by start position C3 (step TB12). Furthermore, recording unit 682 records, or schedules recording of, the TV broadcast program received through TV broadcast receiving unit 681.

For example, assume that a character string “CPLAY NOSTALGIC TELEVISION 3.00” is set in identical viewing and listening command CM, and that this character string is transmitted from conversation device 201 of user B to conversation device 101 of user A in FIG. 17. Identical viewing and listening command CM instructs that the content having a title of “NOSTALGIC TELEVISION” should be replayed from a time point three minutes after the top of the content. In FIG. 17, identical viewing and listening command CM is shown as an “identical replay command”.

In FIG. 17, the identical replay command is initially transmitted from conversation device 201 of user B to conversation device 101 of user A, and at the same time, time measurement with the use of timer 670 is started in conversation device 201. Conversation device 101 of user A receives the identical replay command and interprets the command to perform replay, and in addition, transmits “OK” back to conversation device 201 of user B. In conversation device 201 receiving “OK”, time measurement by timer 670 is completed, so that response time T1, which is time required for receiving the “OK” response from the time point when the identical replay command is transmitted, can be based on the time measured by timer 670. CPU 622 in conversation device 201 of user B estimates (calculates), in anticipation of response time T1, that replay is started in conversation device 101 of user A, time T2 (=T1÷2) before the current time instance shown by timer 670. Then CPU 622 itself modifies an operation to be performed to the content by replay unit 683, which operation is instructed by the identical replay command, such that replay is started from a scene which appears time T2 after the time point when three minutes have passed after the top of the same content. The method of determining time T2 is modified according to the types of communication paths or the procedures of communication. Similarly, in other commands in identical viewing and listening command CM in FIG. 16, the time when the command is executed on the other side is estimated from response time T1, and based on a result of estimation, the operation to be performed to the content by identical viewing and listening command CM is modified, so that replay in its own device is controlled.

When the content to be recorded are selected, a character string “CRECRSV NOSTALGIC TELEVISION” is generated in identical viewing and listening command CM. The generated identical record scheduling command CM is transmitted and executed by recording unit 682, so that scheduling for reliably recording the specified content is made.

Content list 112 and 113, which are mutually exchanged and stored in the other conversation devices, the generated comparison content list 114, and identical content list 115 are discarded when a prescribed condition is established, such as when conversation terminates, when a certain time period has passed, when the user issues an instruction, when the state set by the user is reached (e.g. the time instance specified by the user is reached), or when the same new list is generated (stored). In other words, they are deleted from the corresponding storage units.

### Other Embodiments

The system having a process function described above is implemented by a program. In the present embodiment, the program is stored in a computer-readable recording medium.

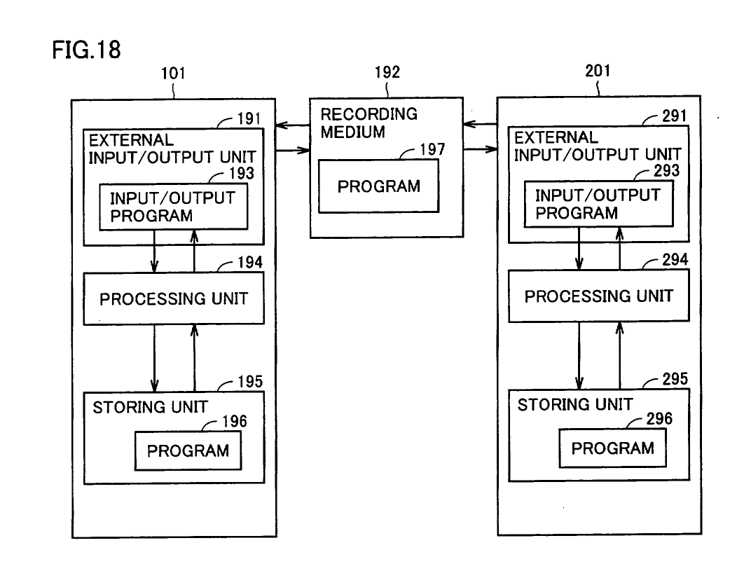

Referring to FIG. 18, such a program 196 is stored in a storage unit 195 in conversation device 101. Program 196 is read and executed by a processing unit 194 so that a prescribed operation is implemented in conversation device 101.

Furthermore, program 196 is read from storing unit 195, and moved or copied to a recording medium 192 by an external input/output control program (copy program) 193 that controls an external input/output unit 191, so that program 196 can be stored in recording medium 192 as a program 197. Furthermore, program 196 can be moved or copied as program 296 to a storing unit 295 in the other conversation device 201, through an input/output program 293 of external input/output unit 291, by utilizing recording medium 192. Program 296 stored in conversation device 201 is read and executed by a processing unit 294, so that a prescribed operation is implemented in conversation device 201.

In the present embodiment, as to a recording medium of a program, a memory itself such as a ROM required for allowing a process to be performed at the computer shown in FIG. 2, which incorporates a conversation device, may serve as a program medium. Alternatively, a medium, which is readable by being inserted into a program reader such as a magnetic tape device or CD-ROM drive 640 provided as an external storing device, may serve as a program medium. For example, a medium may be a magnetic tape corresponding to storage medium 192, or CD-ROM 642. In any case, there may be used a scheme in which CPU 622 accesses and executes a program stored in the recording medium. Alternatively, in any case, there may be used a scheme in which a program is once read from a recording medium and the read program is loaded in a prescribed program storing area in the computer in FIG. 2, such as a program storing area of the RAM, and then the program is read from the program storing area and executed by CPU 622. The program for loading is stored in advance in the computer.

Here, the program medium described above is a recording medium configured to be separable from the computer main body, and the program medium may be a medium carrying a fixed program. For example, such a recording medium includes a tape system such as a magnetic tape or a cassette tape, a disk system including a magnetic disk such as FD 632 or fixed disk (hard disk) 626, or an optical disk such as CD-ROM 642, a Magnetic Optical Disk (MO), a Mini Disk (MD), or a Digital Versatile Disk (DVD), a card system such as an IC card (including a memory card) or an optical card, or a semiconductor memory such as, for example, a Mask ROM, an Erasable and Programmable ROM (EPROM), an Electrically EPROM (EEPROM), or a flash ROM.

In the present embodiment, the computer adopts a configuration allowing itself to be connected to communication network 300 including the Internet, through communication interface 680. Accordingly, the above-described program medium may be a medium carrying a program downloaded from communication network 300. When a program is downloaded from communication network 300, a program for downloading may be stored in advance in the computer main body, or may be installed in advance from another recording medium in the computer main body.

The content stored in the recording medium is not limited to a program, and data may be stored therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content presentation device including a first content storing unit storing a plurality of first contents and first relevant information pieces relating to the first contents, in a manner allowing said first relevant information pieces to correspond to said first contents, respectively, and an output unit, and communicating with an external device,
the external device having a second content storing unit storing a plurality of second contents and second relevant information pieces relating to the second contents, in a manner allowing said second relevant information pieces to correspond to said second contents, respectively,
the content presentation device comprising:
an information receiving unit receiving said second relevant information pieces read from said second content storing unit in said external device and transmitted;
a comparison unit comparing said second relevant information pieces received by said information receiving unit and said first relevant information pieces read from said first content storing unit, and outputting a comparison result; and
a presentation unit retrieving, from said first content storing unit, based on said comparison result output from said comparison unit, a content of said first contents identical to a content of said second contents stored in said second content storing unit in said external device, and presenting the retrieved content of said first contents through said output unit, wherein
in said external device, the content of said second contents identical to the content of said first contents presented at said presentation unit is read from said second content storing unit and presented.

2. The content presentation device according to claim 1, wherein said external device has a configuration similar to a configuration of said content presentation device.

3. The content presentation device according to claim 1, wherein
said content presentation device is connected to a communication line, and
said content presentation device further comprises a speech communication unit for allowing a user of said content presentation device to hold conversation with a user of said external device via said communication line.

4. The content presentation device according to claim 1, wherein said comparison unit has a comparison and matching unit comparing said second relevant information pieces received by said information receiving unit and said first relevant information pieces read from said first content storing unit, and outputting a piece of said first relevant information pieces, which piece is determined to match with a piece of said second relevant information pieces based on a comparison result, as said comparison result.

5. The content presentation device according to claim 1, wherein said first relevant information pieces include first comment data of said first contents corresponding thereto, while said second relevant information pieces include second comment data of said second contents corresponding thereto.

6. The content presentation device according to claim 5, further comprising an information generating unit communicating with an external information processing device storing information on said first contents, and based on the information on said first contents, which information is received from the information processing device, generating said first relevant information pieces, wherein
said comparison unit has an update unit updating said second comment data in said second relevant information pieces received from said external device, by using the information on said first contents, which information is received from said information processing device, for comparison.

7. The content presentation device according to claim 1, wherein
said first and second relevant information pieces include any of a title and an elapsed time list of said first and second contents corresponding thereto, respectively, and
when said first and second contents corresponding thereto are a video picture, said elapsed time list shows a timing at which scenes are switched, and when said first and second contents corresponding thereto are a tune, said elapsed time list shows a time interval for which the tune continues or pauses.

8. The content presentation device according to claim 1, further comprising
a record command generating unit generating a record command for instructing that a desired content is recorded in said first content storing unit, based on an external instruction,
a record command transmitting unit transmitting said record command generated by said record command generating unit to said external device, and
a record command receiving unit receiving said record command transmitted from said external device, wherein
the content presentation device performs
an operation for storing said desired content in said first content storing unit, based on said record command received by said record command receiving unit, and
an operation for storing said desired content in said first content storing unit, based on said record command generated by said record command generating unit.

9. The content presentation device according to claim 1, wherein said second relevant information pieces received from said external device are discarded when a prescribed condition is established.

10. The content presentation device according to claim 1, further comprising
a presentation command generating unit generating a presentation command for instructing an operation for presenting the content of said first contents identical to the content of said second contents through said output unit, based on an external instruction,
a presentation command transmitting unit transmitting said presentation command generated by said presentation command generating unit to said external device,
a first presentation unit retrieving the content of said first contents identical to the content of said second contents from said first content storing unit and presenting the retrieved content of said first contents through said output unit according to the instructed operation, based on said presentation command received from said external device, and
a second presentation unit retrieving the content of said first contents identical to the content of said second contents from said first content storing unit and presenting the retrieved content of said first contents through said output unit according to the instructed operation, based on said presentation command generated by said presentation command generating unit.

11. The content presentation device according to claim 10, further comprising a response measurement unit measuring response time required for transmitting said presentation command to said external device, wherein
when said presentation command is transmitted to said external device by said presentation command transmitting unit, said second presentation unit modifies the operation, which is intended for the contents and instructed by said presentation command, based on said response time measured by said response measurement unit.

12. A program product for executing a content presentation method by using a computer including a first content storing unit storing a plurality of first contents and first relevant information pieces relating to the first contents, in a manner allowing the first relevant information pieces to correspond to said first contents, respectively, and an output unit, and communicating with an external device, wherein
said external device has a second content storing unit storing a plurality of second contents and second relevant information pieces relating to the second contents, in a manner allowing the second relevant information pieces to correspond to said second contents, respectively, and
the content presentation method includes the steps of
receiving said second relevant information pieces read from said second content storing unit in said external device and transmitted;
comparing said second relevant information pieces received by said step of receiving and said first relevant information pieces read from said first content storing unit, and outputting a comparison result; and
retrieving, from said first content storing unit, based on said comparison result output by said step of comparing, a content of said first contents identical to a content of said second contents stored in said second content storing unit, and presenting the content of said first contents through said output unit.

13. A content presentation method by using a computer including a first contents storing unit storing a plurality of first contents and first relevant information pieces relating to the first contents, in a manner allowing the first relevant information pieces correspond to the said first contents, respectively, and an output unit, and communicating with an external device,
said external device having a second content storing unit storing a plurality of second contents and second relevant information pieces relating to the second contents, in a manner allowing the second relevant information pieces to correspond to said second contents, respectively,
the content presentation method comprising the steps of:
receiving said second relevant information pieces read from said second content storing unit in said external device and transmitted;
comparing said second relevant information pieces received by said step of receiving and said first relevant information pieces read from said first content storing unit, and outputting a comparison result; and
retrieving, from said first content storing unit, based on said comparison result output by said step of comparing, a content of said first contents identical to a content of said second contents stored in said second content storing unit, and presenting the content of said first contents through said output unit.
